(19) United States
(12) Patent Application Publication
(10) Pub. No.: US 2025/0004726 A1
(43) Pub. Date: Jan. 2, 2025

(54) RESOURCE CONFIGURATION METHOD AND APPARATUS BASED ON PARASITIC PROGRAM, DEVICE, MEDIUM, AND PRODUCT

(71) Applicant: Tencent Technology (Shenzhen) Company Limited, Shenzhen (CN)

(72) Inventor: Yifei YAN, Shenzhen (CN)

(21) Appl. No.: 18/884,097

(22) Filed: Sep. 12, 2024

Related U.S. Application Data
(63) Continuation of application No. PCT/CN2023/125346, filed on Oct. 19, 2023.

(30) Foreign Application Priority Data
Nov. 29, 2022 (CN) 202211511860.2

(51) Int. Cl. G06F 8/30; G06F 8/20

(52) U.S. Cl. CPC G06F 8/315; G06F 8/24

(57) ABSTRACT

The present application provides a resource configuration method based on a parasitic program running on a host program performed by a computer device. The method includes: generating a prefab file in response to a prefab file generation operation, the prefab file comprising a prefab resource, the prefab resource being configured for generating a prefab instance displayed in a virtual scene of the parasitic program; in response to receipt of a first editing operation on the prefab resource, updating the prefab resource according to the first editing operation; in response to receipt of an instance generation operation, generating a prefab instance corresponding to the prefab resource based on configuration data of an instance performance feature in the prefab resource; and in response to receipt of a scene construction operation, generating the virtual scene in the parasitic program based on the prefab instance, the virtual scene including the prefab instance.

### CROSS-REFERENCE TO RELATED APPLICATIONS

This application is a continuation application of PCT Patent Application No. PCT/CN2023/125346, entitled “RESOURCE CONFIGURATION METHOD AND APPARATUS BASED ON PARASITIC PROGRAM, DEVICE, MEDIUM, AND PRODUCT” filed on Oct. 19, 2023, which claims priority to Chinese Patent Application No. 202211511860.2, entitled “RESOURCE CONFIGURATION METHOD AND APPARATUS BASED ON PARASITIC PROGRAM, DEVICE, MEDIUM, AND PRODUCT” filed on Nov. 29, 2022, both of which are incorporated herein by reference in their entirety.

### FIELD OF THE TECHNOLOGY

Embodiments of this application relate to the field of software development, and in particular, to a resource configuration method and apparatus based on a parasitic program, a device, a medium, and a product.

### BACKGROUND OF THE DISCLOSURE

Applets refer to programs that are parasitic on host programs and run depending on operations of the host programs. The applets may be implemented as game applets, shopping applets, or the like.

In a development process of a game applet, objects and components in game scenes need to be repeated. In the related art, a plurality of repeated objects or components are generated in game scenes of a game applet by copying.

However, generation of repeated objects and components by copying requires repeated human-computer interactions, which is cumbersome to operate, increases the workload of scene development, and reduces the efficiency of scene development.

### SUMMARY

Embodiments of this application provide a resource configuration method and apparatus based on a parasitic program, a device, a medium, and a product.

In one aspect, this application provides a resource configuration method based on a parasitic program running on a host program executed by a computer device, the method including:
generating a prefab file in response to a prefab file generation operation, the prefab file comprising a prefab resource, the prefab resource being configured for generating a prefab instance displayed in a virtual scene of the parasitic program;
in response to receipt of a first editing operation on the prefab resource, updating the prefab resource according to the first editing operation;
in response to receipt of an instance generation operation, generating a prefab instance corresponding to the prefab resource based on configuration data of an instance performance feature in the prefab resource; and
in response to receipt of a scene construction operation, generating the virtual scene in the parasitic program based on the prefab instance, the virtual scene including the prefab instance.

In another aspect, this application provides a computer device including a processor and memory, the memory having at least one program, the at least one program, when loaded and executed by the processor, causing the computer device to implement a resource configuration method based on a parasitic program running on a host program according to any one of the embodiments of this application.

In another aspect, provided is a non-transitory computer-readable storage medium, the storage medium having at least one program, the at least one program, when loaded and executed by a processor of a computer device, causing the computer device to implement a resource configuration method based on a parasitic program running on a host program according to any one of the foregoing embodiments of this application.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe the technical solutions in the embodiments of this application or the related art more clearly, the following briefly describes the accompanying drawings required for describing the embodiments or the related technology. Apparently, the accompanying drawings in the following descriptions show merely some embodiments of this application, and a person of ordinary skill in the art may still derive other drawings from these accompanying drawings without creative efforts.

FIG. 1 is a schematic diagram of a development process of a game applet according to an exemplary embodiment of this application.

FIG. 2 is a flowchart of a resource configuration method based on a parasitic program according to an exemplary embodiment of this application.

FIG. 3 is a schematic diagram of a process of creating a prefab resource provided in the embodiment shown in FIG. 2.

FIG. 4 is a schematic diagram of another process of creating a prefab resource provided in the embodiment shown in FIG. 2.

FIG. 5 is a schematic diagram of a process of modifying and synchronizing a prefab resource provided in the embodiment shown in FIG. 2.

FIG. 6 is a schematic diagram of a process of creating a virtual scene provided in the embodiment shown in FIG. 2.

FIG. 7 is a flowchart of a resource configuration method based on a parasitic program according to another exemplary embodiment of this application.

FIG. 8 is a flowchart of a resource configuration method based on a parasitic program according to another exemplary embodiment of this application.

FIG. 9 is a schematic diagram of a process of instantiating a prefab resource provided in the embodiment shown in FIG. 8.

FIG. 10 is a schematic diagram of a process of merging, through a merge algorithm, prefab resources provided in the embodiment shown in FIG. 8.

FIG. 11 is a structural block diagram of a resource configuration apparatus based on a parasitic program according to an exemplary embodiment of this application.

FIG. 12 is a structural block diagram of a resource configuration apparatus based on a parasitic program according to another exemplary embodiment of this application.

FIG. 13 is a structural block diagram of a server according to an exemplary embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

First, terms involved in the embodiments of this application are briefly introduced.

Prefab resource (Prefab): It is a set of game object data, may be regarded as a template resource, and a game object capable of being instantiated to reuse in a game running process. In developer tools for program development, a prefab resource can be created, edited, or saved. In applets, the prefab resource is usually saved in a json file format.

Prefab instance: It refers to a product after the prefab resource is instantiated, and can be implemented as an object or a component in a virtual scene. Usually, the prefab instance exists in a form of a node tree. For example, in a game scene, the prefab instance can be applied to the game scene during running of the game. In some embodiments, a plurality of prefab instances are mounted in a same node tree in a game scene. For example, a root node is a scene instance and corresponds to a game scene, a plurality of character objects in the game scene are mounted on object nodes under the root node, and a plurality of virtual tree objects in the game scene are mounted on tree nodes under the root node. Trunks are mounted under a tree node to serve as child nodes, as part of the objects. For example, hair, clothes, or the like are mounted under an object node to serve as child nodes, and so on.

The virtual scene involved in the embodiments of this application may be implemented as at least one of the following scenes: 1. a virtual game scene in a game applet; 2. a virtual scene in a virtual reality (VR) applet; 3. a virtual map scene such as a three-dimensional map applet, or the like, which are not limited in the embodiments of this application. In an embodiment of this application, for example, the virtual scene is realized as a virtual scene in a game applet for description. A virtual scene of a game applet usually includes a large number of scene elements, for example, character objects, virtual decorations in the scene, or virtual props in the scene. In addition, many scene elements are repeated. For example, there are a large number of repeated non-player characters (NPCs) and a large number of repeated virtual trees in game scenes. In the related art, there is much data redundancy in the development of game applets, and scene resources cannot be efficiently reused and efficiently modified and maintained.

To improve the editing efficiency of game scene resources and meanwhile maintain the game performance during actual running, in the embodiments of this application, a new scene resource processing procedure is provided, to increase the highly flexible reusing, nesting, recovery, and coverage capabilities of the prefab resources.

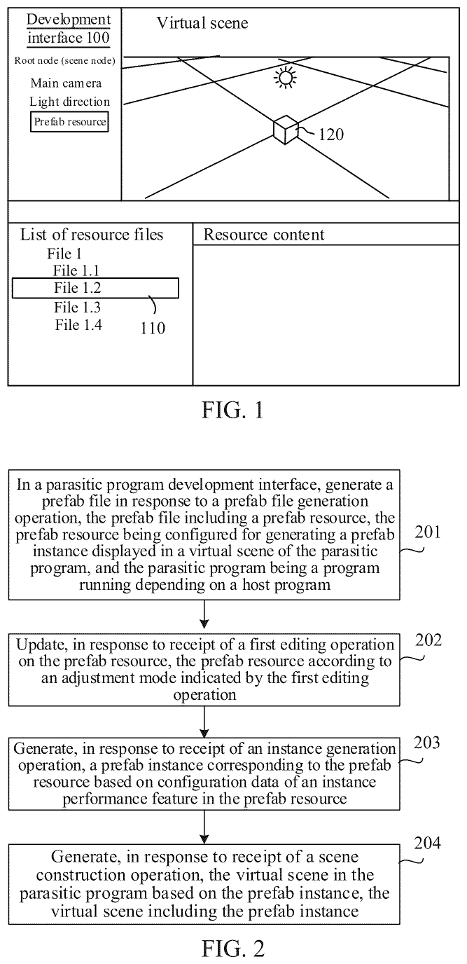

For example, FIG. 1 is a schematic diagram of a development process of a game applet according to an exemplary embodiment of this application. Referring to FIG. 1, firstly, a prefab resource 110 (a file 1.1, a file 1.2, a file 1.3, or a file 1.4 under a file 1 in a list of resource files shown in FIG. 1) is created in an applet development interface 100. The prefab resource 110 is configured for being mapped to a virtual scene to obtain a prefab instance 120. Through a selected operation on the prefab resource 110, the prefab instance 120 displayed in the virtual scene can be generated based on the prefab resource 110 after performing a generation operation based on the selected operation. The prefab resource 110 is a resource capable of being reused. On the basis of the prefab resource 110, a predetermined number of prefab instances 120 can be generated in batch, or the prefab instances 120 can be generated one by one.

Data of the prefab resources and the virtual scenes is data initiatively uploaded or created by a user; or is data obtained after individual authorization by a user. Information (including, but not limited to, user equipment information, user personal information, or the like), data (including, but not limited to, data for analysis, stored data, displayed data, or the like), and signals involved in this application are all authorized by the users alone or fully authorized by all parties, and the collection, use, and processing of relevant data need to comply with relevant laws, regulations, and standards of relevant countries and regions. For example, the virtual scene data or the game data involved in this application are all acquired with sufficient authorization.

Secondly, an implementation environment involved in the embodiments of this application is described. The embodiments of this application may be executed by a terminal, where a host application program is installed on the terminal, and a parasitic program may run in the host application program. For example, the host application program is a search engine program, a travel application program, a life assistance application program, an instant messaging application program, a videos program, or a games program, which is not limited in the embodiments of this application. In some embodiments, the terminal is further installed with an applet development program for developing a parasitic program running in the host application program.

The terminal may be a terminal device in various forms, such as a mobile phone, a tablet computer, a desktop computer, a portable notebook computer, a smart TV set, an in-vehicle terminal, and a smart home device, which is not limited in the embodiments of this application.

Alternatively, in other embodiments, this embodiment of this application may further be jointly executed by a terminal and a server. The server above may be an independent physical server, or a server cluster or distributed system composed of a plurality of physical servers, or may be a cloud server that provides cloud services, cloud databases, and basic cloud services such as cloud computing, cloud functions, cloud storage, network services, cloud communications, middleware services, domain name services, security services, content delivery networks (CDNs), big data, and artificial intelligence platforms.

The cloud technology refers to a hosting technology that unifies series of resources such as hardware, software, and network in a wide area network or a local area network, to implement computing, storage, processing, and sharing of data. The cloud technology is a generic term for a network technology, an information technology, an integration technology, a management platform technology, an application technology, and the like applied based on a cloud computing commercial mode, and can form a pool of resources, which is used on demand and is flexible and convenient. The cloud computing technology is to become an important support. Back-end services of a technology network system require a huge amount of computing and storage resources, such as video websites, image websites, and more portal websites. Accompanied with the high-level development and application of the Internet industry, every item may have its own identification mark in the future, which needs to be transmitted to a back-end system for logical processing. Data at different levels may be processed separately, and various types of industry data require strong system back support, which can only be implemented through cloud computing.

In some embodiments, the server may alternatively be implemented as a node in a blockchain system.

By referring to the noun introduction and application scenarios, the resource configuration method based on the parasitic program provided in this application is illustrated. The method may be executed by a server or a terminal, may alternatively be jointly executed by a server and a terminal. In the embodiments of this application, for example, the method is executed by a terminal, for description. As shown in FIG. 2, the method includes the following operations.

Operation 201: In a parasitic program development interface, generate a prefab file in response to a prefab file generation operation, the prefab file including a prefab resource, the prefab resource being configured for generating a prefab instance displayed in a virtual scene of the parasitic program, and the parasitic program being a program running on a host program.

The parasitic program development interface refers to an interface for developing a parasitic program. The prefab file generation operation refers to an operation of creating a prefab file in the parasitic program, and is an operation by which a prefab resource may be configured in the prefab file, so that the prefab instance can be directly generated in the virtual scene based on the prefab resource.

The prefab resource is configured for configuring display resources of the prefab instance displayed in the virtual scene of the parasitic program. For example, the prefab resource includes code content, configured for expressing an appearance of the prefab instance, for example, a cube instance, a color of which is red, and borders of which are black. The appearance of the prefab instance is expressed in a form of code, serves as a prefab resource, and is stored as a prefab file. In some embodiments, the prefab resource may further be configured for configuring attribute information of the prefab instance, for example, configuring an initial life value of the configured prefab instance as 100. In some embodiments, prefabs may further be configured for configuring a node tree relationship between the prefab resources, for example, packing a prefab instance corresponding to a prefab resource a as a child node of a prefab instance corresponding to a prefab resource b.

In some embodiments, the prefab file generation operation includes at least one of the following execution modes:

In a first mode, a virtual object created in the virtual scene displayed in the parasitic program development interface is directly dragged into a resource management panel corresponding to the prefab file, to automatically generate a prefab file corresponding to the virtual object, and automatically create resource content corresponding to the virtual object in the prefab file. That is, the prefab resource is generated based on the virtual object that has been created, and subsequently a prefab instance having a same appearance as the virtual object can be generated based on the prefab resource.

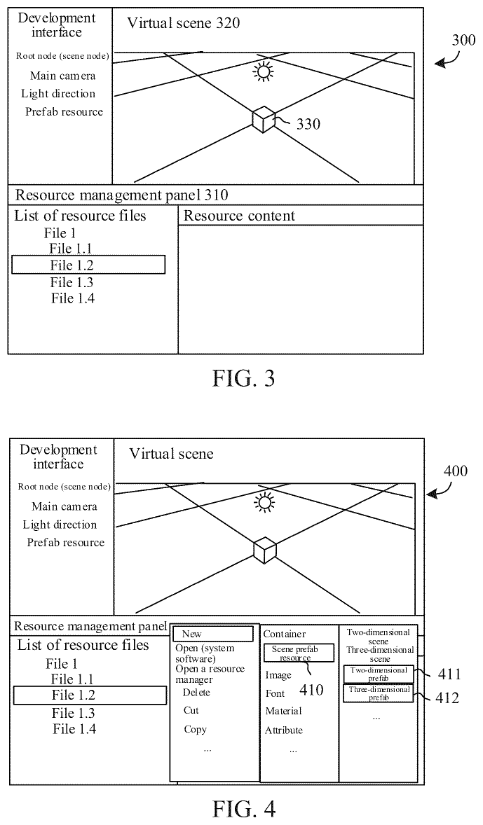

For example, as shown in FIG. 3, the parasitic program development interface may be specifically a scene editor interface 300 of a parasitic program. The scene editor interface 300 includes a resource management panel 310, and a prefab file corresponding to a virtual object 330 can be automatically generated by directly dragging the virtual object 330 in the virtual scene 320 to the resource management panel 310.

In a second mode, in the resource management panel corresponding to the prefab file, a prefab file is directly created and a prefab resource is edited. When the prefab file is initially created, the prefab resource in the prefab file is blank; or, when the prefab file is initially created, a candidate prefab resource corresponding to a candidate shape is first created according to the selected candidate shape and a prefab resource needed is obtained by editing the candidate prefab resource.

For example, as shown in FIG. 4, a scene editor interface 400 of a parasitic program includes a prefab creation option 410 (for example, a scene prefab creation option 410 shown in FIG. 4), and a prefab file is created through a selected operation on the prefab creation option 410. The prefab creation option 410 includes a two-dimensional prefab resource creation option 411 and a three-dimensional prefab resource creation option 412. The two-dimensional prefab resource creation option 411 is configured to create a prefab instance such as a control and a panel. The three-dimensional prefab resource creation option 412 is configured to create a prefab instance such as a virtual object and a virtual character.

The method for generating a prefab file is only a schematic example, and the method for creating a prefab is not limited in the embodiments of this application.

In the embodiments of this application, the parasitic program refers to a program that runs depending on running of a host program, or the parasitic program may alternatively be a program that runs depending on running of an operating system. In some embodiments, the parasitic program may alternatively be referred to as an applet, a fast application, or the like, which is not limited in this embodiment. For example, the parasitic program runs depending on running of a host program for description. After the host program runs, a parasitic program option is provided in the host program, and a parasitic program to be run can be selected from the parasitic program option.

In the embodiments of this application, the host program may be implemented as an instant messaging application layer program, a social program, a shopping program, a game application program, a short video program, which is not limited in this embodiment. The parasitic program may be implemented as a game applet, a virtual reality applet, a scene simulation applet, a map applet, a navigation applet, or the like, which is not limited in this embodiment.

Operation 202: Update, in response to receipt of a first editing operation on the prefab resource, the prefab resource according to an adjustment mode indicated by the first editing operation.

The first editing operation on the prefab resource is configured for changing a performance feature of the prefab instance corresponding to the prefab resource in the virtual scene. The performance feature of the prefab instance in the virtual scene is embodied in aspects such as appearance and attribute performance. By the first editing operation on the prefab resource, performance of a prefab instance subsequently generated based on the prefab resource is adjusted.

In some embodiments, the first editing operation on the prefab resource may be specifically editing and modifying a node in an instance tree. After editing and modifying a node in the instance tree, the prefab resource corresponding to the instance tree may be updated based on a confirmation operation on the root node. The instance tree refers to a tree composed of prefab instances displayed in a virtual scene, and each prefab instance displayed in the virtual scene corresponds to a node in the instance tree, that is, the prefab instances displayed in the virtual scene are respectively in one-to-one correspondence to the nodes in the instance tree.

In some embodiments, the editing operation on the prefab resource includes at least one of the following modes:

In a first mode, a first selection operation on a prefab file is received, prefab resource content in the prefab file is displayed in response to the first selection operation, where the prefab resource content is configured for characterizing a performance feature of a prefab instance corresponding to the prefab resource, a second editing operation on the prefab resource content is received, and the prefab resource is updated based on the second editing operation.

The prefab file is a file that has been created in a parasitic program development program, and there may be a plurality of prefab files. The first selection operation refers to an operation of selecting a prefab file. The prefab resource content is code content or configuration content configured for characterizing a performance feature of the prefab instance corresponding to the prefab resource. The second editing operation refers to an editing operation on the prefab resource content, the prefab resource content may be modified by the second editing operation, and further the prefab resource may be updated based on the modified prefab resource content.

In some embodiments, the terminal may receive a first selection operation on the prefab file, and display prefab resource content in the prefab file in response to the first selection operation, where the prefab resource content is configured for characterizing a performance feature of the prefab instance corresponding to the prefab resource, and the performance feature of the prefab instance corresponding to the prefab resource may be adjusted by editing and modifying the prefab resource content. Upon receipt of a second editing operation on the prefab resource content, the terminal may update the prefab resource based on the second editing operation.

In some embodiments, a list of prefab files may be displayed in a parasitic program development program, a first selection operation on the prefab file may be specifically an operation of selecting a prefab file from the displayed list of prefab files, the prefab resource content in the prefab file displayed in response to the first selection operation is prefab resource content of the prefab file selected from the list of prefab files.

In some embodiments, performing a second editing operation on the prefab resource content may specifically include editing code content corresponding to the prefab resource, or editing a configuration item corresponding to the prefab resource. For example, a color configuration item of the prefab instance included in the prefab resource is configured as red, and the color red is updated to yellow by an editing operation.

For example, in a resource management panel of the parasitic program development program, a double-click operation on the prefab file is received as the first selection operation, the prefab resource content of the prefab file is displayed, and the second editing operation, that is, a direct modification operation, on the prefab resource content is received.

In a second mode, a prefab reference instance corresponding to the prefab resource is displayed in a reference scene, an adjustment operation on the prefab reference instance is received, and the prefab resource is updated based on the adjustment operation.

In some embodiments, after a fifth selection operation on the prefab file is received, a prefab reference instance corresponding to the prefab resource of the prefab file is displayed in the reference scene, where the prefab reference instance is configured for characterizing a performance feature of the prefab instance in the virtual scene after the prefab instance is generated from the prefab resource.

In some embodiments, the reference scene is the same as an actual running virtual scene, or the reference scene is a default blank scene, which is configured for separately characterizing the selected prefab instance.

In some embodiments, by using a prefab reference instance, a performance feature of the prefab instance corresponding to the prefab resource when displayed in the virtual scene may be determined, so that the adjustment operation of the performance feature of the prefab instance corresponding to the prefab resource when displayed in the virtual scene may be adjusted by adjusting the prefab reference instance. The prefab instance corresponding to the prefab resource refers to a prefab instance that can be generated based on the prefab resource. After receiving the adjustment operation on the prefab reference instance, the terminal may update, in response to the adjustment operation, the prefab resource based on the adjustment operation, that is, update a configuration parameter of an instance performance feature in the prefab resource, so as to adjust the performance feature of the prefab instance corresponding to the prefab resource when displayed in the virtual scene.

The instance performance feature refers to a performance feature of the prefab instance corresponding to the prefab resource when displayed in the virtual scene. The performance feature can be understood as an expressed feature, such as appearance, or attribute information. The configuration parameter refers to a parameter for configuring an instance performance feature and can be configured according to an actual application scenario. For example, the instance performance feature may be specifically an appearance, and the configuration parameter may be a specific color, such as red or yellow.

In some embodiments, the terminal displays, in response to the adjustment operation, an adjustment configuration area, and updates the prefab resource based on a configuration parameter selected in the adjustment configuration area. For example, the prefab reference instance may be a prefab parameter character, and the prefab file includes a prefab resource corresponding to the virtual object; after receiving the fifth selection operation on the prefab file, the terminal may display a reference scene, and display the prefab reference character corresponding to the prefab resource in the reference scene. In this case, the adjustment operation on the prefab reference instance may be a selection operation on any part of the prefab reference character, the selection operation on any part of the prefab reference character is received, and the terminal may display a color selection area, where the color selection area includes a pixel value filling area for directly filling a pixel value of a selected part, or the color selection area includes a plurality of candidate colors for selection. Upon receipt of a selection operation on yellow in the color selection area, the color of the selected part of the prefab reference character is adjusted to yellow, and the prefab resource content is automatically updated correspondingly. The selected part may be at least one of a part such as hair or an arm, which is not specifically limited in this embodiment.

In some embodiments, the adjustment operation on the prefab reference instance is a visual adjustment operation, that is, for receipt of the visual adjustment operation on the prefab reference instance, the prefab resource is updated based on the visual adjustment operation in response to receipt of a confirmation operation on the visual adjustment operation. That is, in a single group of operations, a plurality of visual adjustment operations on a prefab reference instance may be received, and a plurality of visual adjustment operations on different prefab reference instances under a same instance tree may be received. After all of the visual adjustment operations are confirmed, a confirmation operation on the plurality of visual adjustment operations is received, so as to update the prefab resource based on the confirmation operation and the plurality of visual adjustment operations.

In some embodiments, after modifying the prefab instance in the reference scene, a root node is right-clicked. For example, in a scene instance node, a confirmation control is clicked to synchronize modified content to the prefab resource corresponding to the prefab tree.

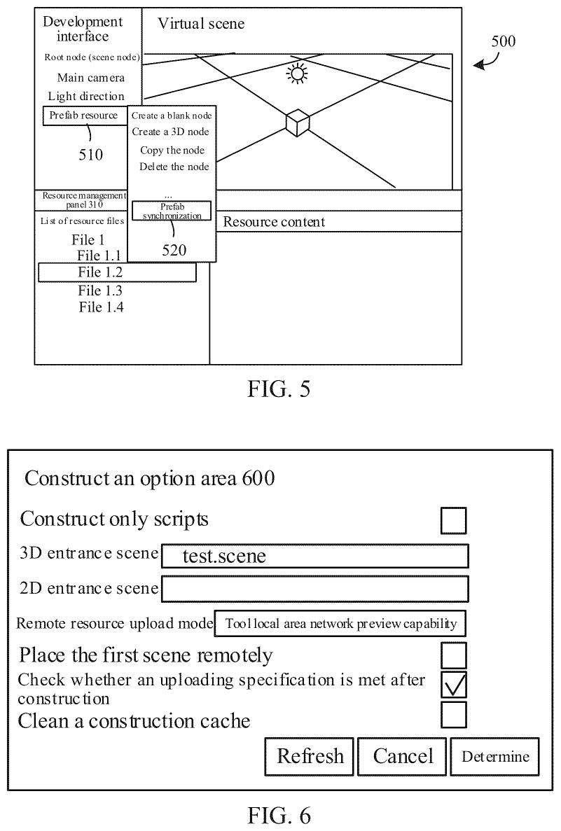

For example, referring to FIG. 5, a scene editor interface 500 of a parasitic program includes a resource option 510 of a prefab root node. When a selection operation on the resource option 510 of the prefab root node is received, a synchronization option 520 for prefab synchronization is displayed, and modified content of the prefab reference instance in the reference scene is synchronized to a prefab resource through the synchronization option 520 for prefab synchronization.

An updating operation on the prefab resource is merely a schematic example, which is not limited in this embodiment.

Operation 203: Generate, in response to receipt of an instance generation operation, a prefab instance corresponding to the prefab resource based on configuration data of an instance performance feature in the prefab resource.

Specifically, the instance generation operation is configured for instructing to generate a prefab instance corresponding to a prefab resource in a virtual scene, and in response to receipt of an instance generation operation, the terminal may instantiate configuration data of an instance performance feature in the prefab resource, to generate a prefab instance corresponding to the prefab resource.

Operation 204: Generate, in response to receipt of a scene construction operation, the virtual scene in the parasitic program based on the prefab instance, the virtual scene including the prefab instance.

Specifically, in response to receipt of the scene construction operation, the terminal may generate the virtual scene in the parasitic program based on the prefab instance, where the virtual scene includes the prefab instance. In some embodiments, the scene construction operation may be a construction operation triggered for a root node instance in the prefab instance. In some embodiments, for example, the scene instance is a root node instance. After the scene resource is created, the virtual scene can be constructed by receiving the construction operation on the scene instance.

For example, as shown in FIG. 6, when the scene construction operation in the resource management panel is received, a construction option area 600 is displayed, and resource options (as shown in FIG. 6, including only constructing only scripts, a three-dimensional (3D) entrance scene, a two-dimensional (2D) entrance scene, a remote resource uploading mode, placing the first scene remotely, checking whether an uploading specification is met after construction, clearing a construction cache, or the like) for creating the virtual scene are included in the construction option area 600, and a virtual scene is created based on a confirmation operation on resource options (specifically, a trigger operation of an “OK” control shown in FIG. 6).

For example, in a game applet, after construction is completed, the game applet can be previewed by scanning on a real machine. In this case, performance of a game object in a game scene is exactly the same as that at the time of editing, and has higher performance than that at the time of editing. The real machine refers to a computer device actually used, for example, a terminal actually used.

In summary, by the method provided in this embodiment, in a process of developing a parasitic program, a prefab instance is generated by creating a prefab file, so that the efficiency of creating identical instances in the parasitic program is improved, the problems of a large resource occupation and a relatively complicated development process caused by generating identical instances by copying are avoided, the efficiency of human-computer interaction is improved, the workload of scene development is reduced, and the efficiency of scene development is increased.

In the method provided in this embodiment, the prefab resource content is displayed by performing the first selection operation on the prefab file, and the prefab resource is updated based on the second editing operation on the prefab resource content, so that the efficiency of modification and editing of the prefab is improved, the workload of scene development is reduced, and the efficiency of scene development is increased.

In the method provided in this embodiment, by performing the visual adjustment operation on the prefab reference instance in the reference scene, a more intuitive example modification scheme is improved, the human-computer interaction efficiency in a process of modifying a prefab instance is improved, the workload of scene development is reduced, and the efficiency of scene development is improved.

In an embodiment, a reverting operation and an unpack operation are further provided in the parasitic program development program in this embodiment of this application. FIG. 7 is the flowchart of a resource configuration method of a parasitic program according to another embodiment of this application. The method may be executed by a server or a terminal, may alternatively be jointly executed by a server and a terminal. In the embodiments of this application, for example, the method is executed by a terminal, for description. As shown in FIG. 7, the method includes the following operations.

Operation 701: In a parasitic program development interface, generate a prefab file in response to a prefab file generation operation, the prefab file including a prefab resource, the prefab resource being configured for generating a prefab instance displayed in a virtual scene of the parasitic program, and the parasitic program being a program running on a host program.

Operation 702: Update, in response to receipt of a first editing operation on the prefab resource, the prefab resource according to an adjustment mode indicated by the first editing operation.

The first editing operation on the prefab resource is configured for changing a performance feature of the prefab instance corresponding to the prefab resource in the virtual scene. The performance feature of the prefab instance in the virtual scene is embodied in aspects such as appearance and attribute performance. By the first editing operation on the prefab resource, performance of a prefab instance subsequently generated based on the prefab resource is adjusted.

In some embodiments, after editing and modifying a node in the instance tree, the prefab resource corresponding to the instance tree may be updated based on a confirmation operation on the root node.

Operation 703: Revert, in response to receipt of a reverting operation on the prefab resource, the prefab resource content back to content before at least one editing operation.

In some embodiments, the method for receiving the reverting operation includes at least one of the following modes:

### 1. An Initialization Reverting Operation (Prefab Revert) is Received

In some embodiments, the initialization reverting operation is configured for restoring entire modified content of the prefab resource, that is, removing all modifications to the prefab instance in the virtual scene and restoring an initial form of the prefab instance. For example, after the selection operation on the prefab file is received and the initialization reverting operation is performed, the prefab instance corresponding to the prefab file is restored to the initial form.

For example, the initialization reverting operation may alternatively be referred to as a first reverting operation, and in response to receipt of the first reverting operation on the prefab resource, the terminal may revert the prefab resource content to initial content, where the initial content is content of the prefab resource when generated, that is, content included in the prefab resource when the prefab resource is generated.

### 2. A Selected Reverting Operation is Received

In some embodiments, in response to receipt of a second reverting operation on the prefab resource, a historical editing option is displayed, where the historical editing option includes an editing operation received within a historical period of time. In response to receipt of a third selection operation on an i^{th} editing option, the prefab resource is reverted back to content after an i^{th} editing operation, where i is a positive integer.

For example, after a specified prefab resource is created, a plurality of editing operations on the specified prefab resource are received successively, respectively in the following order: an editing operation 1, an editing operation 2, an editing operation 3, and an editing operation 4. After a second reverting operation on the specified prefab resource is received, historical editing options are displayed, which include options respectively corresponding to the editing operation 1, the editing operation 2, the editing operation 3, and the editing operation 4. When a third selection operation on the option corresponding to editing operation 2 is received, the specified prefab resource is returned to resource content after the editing operation 2, that is, content edited by the editing operation 1 and the editing operation 2.

In some embodiments, in response to receipt of a second reverting operation on the prefab resource, a historical editing option is displayed, where the historical editing option includes an editing operation received within a historical period of time. In response to receipt of a fourth selection operation on the i^{th} editing option, the prefab resource is reverted back to content before an i^{th} editing operation, where i is a positive integer.

For example, after a specified prefab resource is created, a plurality of editing operations on the specified prefab resource are received successively, respectively in the following order: an editing operation 1, an editing operation 2, an editing operation 3, and an editing operation 4. After a second reverting operation on the specified prefab resource is received, historical editing options are displayed, which include options respectively corresponding to the editing operation 1, the editing operation 2, the editing operation 3, and the editing operation 4. When a fourth selection operation on the option corresponding to the editing operation 2 is received, the specified prefab resource is returned to the resource content before the editing operation 2, that is, content edited by the editing operation 1.

In some embodiments, the third selection operation and the fourth selection operation are not limited in this embodiment, as long as the third selection operation and the fourth selection operation are different. For example, the third selection operation may be specifically a double-click operation on the editing option, and the fourth selection operation may be specifically a one-click operation on the editing option. Still for example, the third selection operation may be specifically a one-click operation on the editing option, and the fourth selection operation may be specifically a double-click operation on the editing option.

The foregoing reverting mode is merely a schematic example, and a specific method for executing the reverting operation is not limited in this embodiment of this application.

In an embodiment, an unpack (Prefab Unpack) operation may further be performed on the prefab instance. In some embodiments, after the prefab instance in the virtual scene is selected and the unpack operation is executed, the prefab instance is written into the scene resource of the virtual scene, and a connection between the prefab instance and the prefab resource is disconnected. That is, subsequent updating and editing operations on the prefab resource does not affect the prefab instance.

In related art, for example, for a virtual character, the structure of the scene resource in the virtual scene usually includes: 1. a name of a virtual character; 2. a subscript (that is, a sub-object identity) of a sub-object of the virtual character in a virtual character array; 3. subscripts of all components of the virtual character in a list of scenes (that is, identities in the scene). Because information of all entities and components is saved in the resource file and information of a dependent prefab instance is lost, the virtual scene and the prefab become independent resources.

In some embodiments, after operation 703, an instance generation operation or a scene construction operation may further be continued.

In summary, by the method provided in this embodiment, in a process of developing a parasitic program, a prefab instance is generated by creating a prefab file, so that the efficiency of creating identical instances in the parasitic program is improved, the problems of a large resource occupation and a relatively complicated development process caused by generating identical instances by copying are avoided, the efficiency of human-computer interaction is improved, the workload of scene development is reduced, and the efficiency of scene development is increased.

In the method provided in this embodiment, the editing and updating operations acted on the prefab resource are reverted back through the reverting operation, so as to avoid a process of repeatedly operating and updating because the prefab resource cannot be updated as expected during the updating process of the prefab instance, so that the efficiency of human-computer interaction is improved, the workload of scene development is reduced, and the efficiency of scene development is improved.

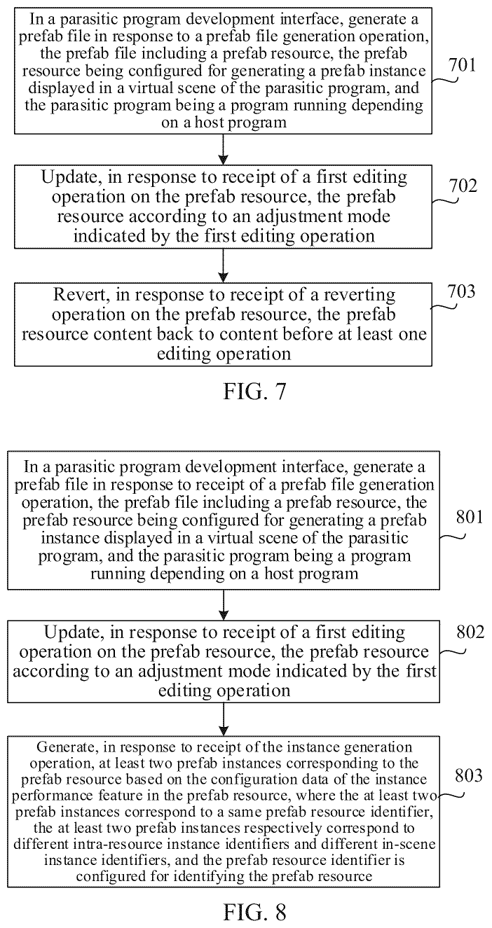

In an embodiment, a prefab identifier of personalized design is further provided in the parasitic program development program in the embodiments of this application. FIG. 8 is the flowchart of a resource configuration method of a parasitic program according to another embodiment of this application. The method may be executed by a server or a terminal, may alternatively be jointly executed by a server and a terminal. In the embodiments of this application, for example, the method is executed by a terminal, for description. As shown in FIG. 8, the method includes the following operations.

Operation 801: In a parasitic program development interface, generate a prefab file in response to receipt of a prefab file generation operation, the prefab file including a prefab resource, the prefab resource being configured for generating a prefab instance displayed in a virtual scene of the parasitic program, and the parasitic program being a program running on a host program.

Operation 802: Update, in response to receipt of a first editing operation on the prefab resource, the prefab resource according to an adjustment mode indicated by the first editing operation.

Operation 803: Generate, in response to receipt of the instance generation operation, at least two prefab instances corresponding to the prefab resource based on the configuration data of the instance performance feature in the prefab resource, where the at least two prefab instances correspond to a same prefab resource identifier, the at least two prefab instances respectively correspond to different intra-resource instance identifiers and different in-scene instance identifiers, and the prefab resource identifier is configured for identifying the prefab resource.

The at least two prefab instances respectively corresponding to different intra-resource instance identifiers means that the intra-resource entity identifiers corresponding to different prefab instances are different. For example, the at least two prefab entities include a first prefab instance and a second prefab instance. The at least two prefab instances respectively corresponding to different intra-resource instance identifiers means that the first prefab instance corresponds to a first intra-resource instance identifier, and the second prefab instance corresponds to a second intra-resource instance identifier.

The at least two prefab instances respectively corresponding to different in-scene instance identifiers means that the in-scene entity identifiers corresponding to different prefab instances are different. For example, the at least two prefab entities include a first prefab instance and a second prefab instance. The at least two prefab instances respectively corresponding to different in-scene instance identifiers means that the first prefab instance corresponds to a first in-scene instance identifier and the second prefab instance corresponds to a second in-scene instance identifier.

The intra-resource instance identifier refers to a unique identifier of the prefab entity in the resource file, and the prefab resource identifier refers to a unique identifier of a prefab resource referenced by a node of the prefab instance, which is configured for identifying the prefab resource. The in-scene instance identifier refers to a unique identifier of the prefab instance in the current scene resource. For example, the prefab instance is a virtual object or component in a virtual scene, the intra-resource instance identifier refers to a unique identifier (localid) of the virtual object or component in the resource file, the prefab resource identifier refers to a unique identifier (prefebuuid) of the prefab resource referenced by the node of the virtual object or component, and the in-scene instance identifier refers to a unique identifier (prefabInstanceLocalId) of the prefab instance in the current scene resource, the object instance and the component instance in the virtual scene can be uniquely determined by the foregoing identifiers. The intra-resource instance identifier, the prefab resource identifier, and the in-scene instance identifiers are fields included in the structure of the scene resource in the virtual scene. In some embodiments, the structure of the scene resource in the virtual scene further includes a field that identifies whether the node pertains to the prefab root node, difference data between the prefab instance and the prefab resource indicates a difference between the prefab instance and the resource after the prefab instance is generated and the prefab resource is updated.

In some embodiments, the resource configuration method based on the parasitic program further includes:
when the resource content of the resource prefab resource is updated and an instantiation operation on the prefab resource is received, updating the at least two prefab instances corresponding to the prefab resource identifiers based on updated resource content of the prefab resource.

Specifically, when the resource content of the resource prefab resource is updated and an instantiation operation on the prefab resource is received, the terminal may update the at least two prefab instances corresponding to the prefab resource identifiers based on updated resource content of the prefab resource.

The prefab resource identifiers (prefebuuid) are configured for avoiding the problem of nested prefabs in a virtual scene. For example, when the prefab resource is updated, through the prefebuuid of the prefab resource, the prefab resource associated with the prefebuuid in the virtual scene is indexed for corresponding modification. Because the prefebuuid expresses an identifier of the prefab resource, that is, an identifier for performing association packing of the prefab instance with the prefab resource. When there is a change in the prefab resource of the prefebuuid, the change may be synchronized to the prefab instance through an index of the prefebuuid for unified adjustment. For example, a prefab object a1, a prefab object a2, and a prefab object a3 are sequentially generated by specifying an order of prefab resources. The prefab object a1, the prefab object a2, and the prefab object a3 correspond to a prefebuuid the same as that of the specified prefab instance. When resource content of the specified prefab resource changes, if an instantiation operation on the specified prefab resource is received, the prefab object a1, the prefab object a2, and the prefab object a3 in the virtual scene are determined by indexing, and the changes in the resource content in the prefab resource are synchronized to performance features of the prefab object a1, the prefab object a2, and the prefab object a3.

In this embodiment, when that the resource content of the resource prefab changes and an instantiation operation on the prefab resource is received, the at least two associated and packed prefab instances are synchronously updated by using the prefab resource identifier, so that the workload of scene development is reduced and the efficiency of scene development is improved.

In some embodiments, the resource configuration method based on the parasitic program further includes:
packing, in response to a pack operation on a first prefab instance identified by a first intra-resource instance identifier, the first prefab instance to a second prefab instance indicated by the pack operation, and updating the prefab resource.

Specifically, when the first prefab instance needs to be packed to the second prefab instance, the object using the terminal may trigger the pack operation to the first prefab instance identified by the first intra-resource instance identifier, and the terminal packs the first prefab instance to the second prefab instance indicated by the pack operation and updates the prefab resource in response to the pack operation to the first prefab instance identified by the first intra-resource instance identifier. In some embodiments, packing the first prefab instance to the second prefab instance indicated by the pack operation may specifically refer to packing the first prefab instance to a second node of the second prefab instance as a child node, that is, packing the first prefab instance as a child node of the second node in the node tree corresponding to the prefab resource.

For example, the intra-resource instance identifier (localid) is a unique identifier corresponding to the virtual object or component in the prefab resource file, to generate a virtual object based on the prefab resource. That is, after a plurality of virtual objects are generated based on the prefab resource, different identifiers corresponding to the prefab resource are assigned to different virtual objects. In some embodiments, localids are assigned to virtual objects generated by specifying prefab resources through sequential numbering. For example, the prefab object a1, the prefab object a2, and the prefab object a3 are sequentially generated according to a specified order of the prefab resources. Therefore, upon receipt of a personalized modification to one of the virtual objects, or when one of the virtual objects changes in the virtual scene according to the scene, the change occurs pertinently, and does not affect the virtual objects generated by using other specified prefab resources. For example, after the localids are assigned to the prefab instances generated by the specified prefab resources by using different identifiers, one of the specified prefab instances is packed as a child node under the node tree of the target prefab instance in the virtual scene, and the localids of the specified prefab instance are packed as child nodes under the node of the target prefab instance; in addition, the prefab instances generated by using other specified prefab resources are not affected and are not synchronously packed to nodes of the target prefab instance. For example, it is expected that virtual clothes A and virtual clothes B are generated by using the prefab resource. The virtual clothes A correspond to a localidA and the virtual clothes B correspond to a localidB. After the virtual clothes A are mounted on a prefab virtual character, the localidA is packed to a child node of the prefab virtual character, and a new prefab resource is generated by updating.

In this embodiment, personalized processing can be performed on the identified first prefab instance by using the first intra-resource instance identifier without affecting other prefab instances, so that packing errors can be reduced, the workload of scene development can be reduced, and the efficiency of scene development can be improved.

In some embodiments, the resource configuration method based on the parasitic program further includes:
modifying, in response to a modification operation on a third prefab instance identified by an in-scene instance identifier, the third prefab instance in a modification mode indicated by the modification operation, and generating a scene resource corresponding to the modification operation.

Specifically, the terminal may modify, in response to a modification operation on a third prefab instance identified by an in-scene instance identifier, the third prefab instance in a modification mode indicated by the modification operation, and generate a scene resource corresponding to the modification operation. The modification herein may be specifically a modification to a performance feature of the third prefab instance.

The in-scene instance identifier (prefabInstanceLocalId) is configured for avoiding the problem of reference to identifiers of a plurality of identical prefab resources in one virtual scene. For example, a prefab instance A and a prefab instance B are created based on the specified prefab resource. After the prefab instance A is modified, the modification is packed with a prefabInstanceLocalId of the prefab instance A, and a corresponding scene resource is generated, to prevent the modification from being synchronized to the prefab instance B.

In this embodiment, personalized processing can be performed on the identified third prefab instance by using the first in-scene instance identifier without affecting other prefab instances, so that modification errors can be reduced, the workload of scene development cane be reduced, and the efficiency of scene development can be improved.

In some embodiments, in a process of instantiation, the unique identifier of the prefab instance in the virtual scene, that is, an object instance identifier (gameObjectId) or a component instance identifier (componentId) may be generated by using an MD5 message-digest algorithm by using the identifier as a parameter. In addition, difference data (diffData) is added to the prefab resource, to record difference data between the prefab resource referenced by the current node and the prefab instance of the node, so that the capability of secondary modification based on the prefab resource after referencing the prefab resource. In some embodiments, the difference data can express modified content of the prefab resource after the prefab instance is generated; or content of the prefab instance changing according to the virtual scene after the prefab instance is generated, which is not limited in the embodiments of this application.

After the data fields are added, the flexibility of editing game scene resources can be improved. To keep rendering of an original game engine unchanged and not affecting the performance of instantiating a scene on a real machine, a new game scene resource loading and construction process is designed.

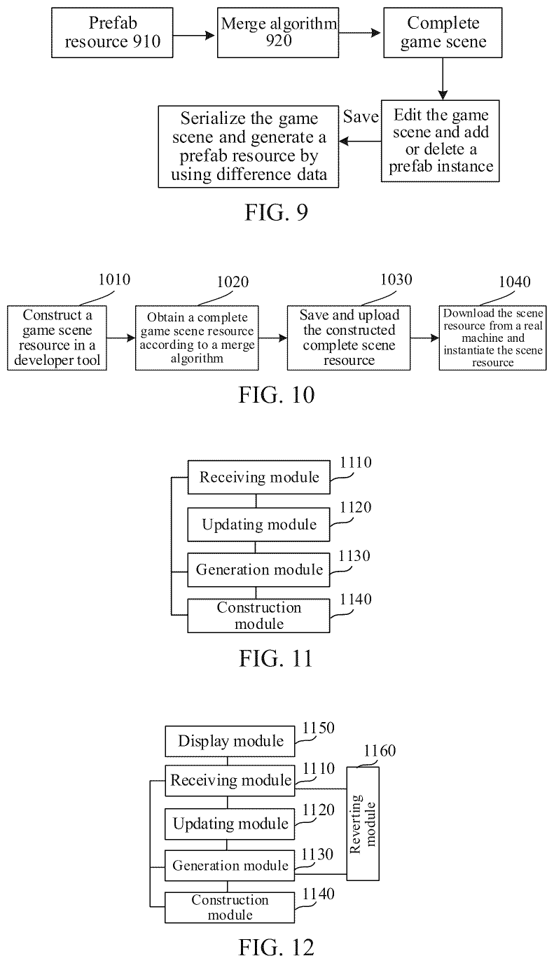

As shown in FIG. 9, in a process of instantiating a prefab resource, all prefabs on which a current prefab resource 910 depends are recursively loaded. After child prefab resources are loaded, node trees of the child prefabs are connected to nodes of a parent prefab, and node data of the child prefabs is merged, through a merge algorithm 920 (merge), according to the difference data diffData. By the merge algorithm, a virtual object and a component are uniquely identified by calculating a gameObjectId and a componentId, and then corresponding new data in the diffData is updated to the corresponding virtual object and component. After the scene modification is completed in a developer tool, the game scene needs to be serialized, a node of a dependent sub-prefab needs to be eliminated by using a difference algorithm, and modified data on the sub-prefab resource need to be calculated. Finally, only difference data diffData between the unique ID of the sub-prefab resource, that is, the prefabUuid, and the sub-prefab is saved.

To ensure the efficiency of real machine resource loading and instantiation, as shown in FIG. 10, a merge operation of the merge algorithm is performed only when the real machine is not run in the embodiments of this application, and a complete game scene tree is obtained through the merge algorithm when a resource needs to be constructed in the developer tool. The process includes: 1010: constructing a game scene resource in a developer tool; 1020: obtaining a complete game scene resource through a merge algorithm; 1030: saving and uploading the constructed complete scene resource; and 1040: downloading and instantiating the scene resource in a real machine.

In some embodiments, after operation 803, an instance generation operation or a scene construction operation may further be continued.

In some embodiments, a scene editing operation on the virtual scene is received, where the scene editing operation is configured for instructing to edit a scene element in the virtual scene and the scene element includes a prefab instance; and in response to receipt of a storage operation on the virtual scene, the prefab resource corresponding to the prefab instance is updated based on the storage operation.

In summary, by the method provided in this embodiment, in a process of developing a parasitic program, a prefab instance is generated by creating a prefab file, so that the efficiency of creating identical instances in the parasitic program is improved, the problems of a large resource occupation and a relatively complicated development process caused by generating identical instances by copying are avoided, the efficiency of human-computer interaction is improved, the workload of scene development is reduced, and the efficiency of scene development is increased.

By the method provided in this embodiment, by designing each identifier corresponding to the prefab instance, the prefab instance is uniquely indicated in different dimensions, so that the flexibility of editing game scene resources can be improved. To keep rendering of an original game engine unchanged and not affecting the performance of instantiating a scene on a real machine, a new game scene resource loading and construction process is designed.

FIG. 11 is a structural block diagram of a resource configuration apparatus based on a parasitic program according to an exemplary embodiment of this application. As shown in FIG. 11, the apparatus includes:
a receiving module 1110, configured to: in a parasitic program development interface, generate a prefab file in response to a prefab file generation operation, the prefab file including a prefab resource, the prefab resource being configured for generating a prefab instance displayed in a virtual scene of the parasitic program, and the parasitic program being a program running on a host program;
an updating module 1120, configured to update, in response to receipt of a first editing operation on the prefab resource, the prefab resource according to an adjustment mode indicated by the first editing operation;
a generation module 1130, configured to generate, in response to receipt of an instance generation operation, a prefab instance corresponding to the prefab resource based on configuration data of an instance performance feature in the prefab resource; and
a construction module 1140, configured to generate, in response to receipt of a scene construction operation, the virtual scene in the parasitic program based on the prefab instance, the virtual scene including the prefab instance.

In an embodiment, the receiving module 1110 is further configured to receive a first selection operation on the prefab file. As shown in FIG. 12, the resource configuration apparatus based on the parasitic program further includes:
a display module 1150, configured to display, in response to the first selection operation, prefab resource content in the prefab file, where the prefab resource content is configured for characterizing a performance feature of the prefab instance corresponding to the prefab resource;
the receiving module 1110 being further configured to receive a second editing operation on the prefab resource content; and
the updating module 1120 being further configured to update the prefab resource based on a second editing operation.

In an embodiment, the resource configuration apparatus based on the parasitic program further includes:
a display module 1150, configured to display a prefab reference instance corresponding to the prefab resource in the reference scene;
the receiving module 1110 being further configured to receive an adjustment operation on the prefab reference instance; and
the updating module 1120 being further configured to update the prefab resource based on the adjustment operation.

In an embodiment, the receiving module 1110 is further configured to receive a visual adjustment operation on the prefab reference instance, and the updating module 1120 is further configured to update, in response to receipt of a confirmation operation for the visual adjustment operation, the prefab resource based on the visual adjustment operation.

In an embodiment, the resource configuration apparatus based on the parasitic program further includes:
a reverting module 1160, configured to revert, in response to receipt of a reverting operation on the prefab resource, the prefab resource content back to content before at least one editing operation.

In an embodiment, the reverting module 1160 is further configured to revert, in response to receipt of a first reverting operation on the prefab resource, the prefab resource content back to initial content, where the initial content is content of the prefab resource when generated.

The reverting module 1160 is further configured to display, in response to receipt of a second reverting operation on the prefab resource, a historical editing option, where the historical editing option includes an editing operation received within a historical period of time, and revert, in response to receipt of a third selection operation on an i^{th} editing option, the prefab resource to content after an i^{th} editing operation, where i is a positive integer.

In an embodiment, the reverting module 1160 is further configured to display, in response to receipt of a second reverting operation on the prefab resource, a historical editing option, where the historical editing option includes an editing operation received within a historical period of time, and revert, in response to receipt of a fourth selection operation on an i^{th} editing option, the prefab resource to content before an i^{th} editing operation, where i is a positive integer.

In an embodiment, the generation module 1130 is further configured to generate, in response to receipt of the instance generation operation, at least two prefab instances corresponding to the prefab resource based on the configuration data of the instance performance feature in the prefab resource, where the at least two prefab instances correspond to a same prefab resource identifier, the at least two prefab instances respectively correspond to different intra-resource instance identifiers and different in-scene instance identifiers, and the prefab resource identifier is configured for identifying the prefab resource.

In an embodiment, the updating module 1120 is further configured to: when the resource content of the resource prefab resource is updated and an instantiation operation on the prefab resource is received, update the at least two prefab instances corresponding to the prefab resource identifier based on updated resource content of the prefab resource.

In an embodiment, the updating module 1120 is further configured to pack, in response to a pack operation on a first prefab instance identified by a first intra-resource instance identifier, the first prefab instance to a second prefab instance indicated by the pack operation, and updating the prefab resource.

In an embodiment, the updating module 1120 is further configured to modify, in response to a modification operation on a third prefab instance identified by a first in-scene instance identifier, the third prefab instance in a modification mode indicated by the modification operation, and generate a scene resource corresponding to the modification operation.

In an embodiment, the receiving module 1110 is further configured to receive a scene editing operation on the virtual scene, where the scene editing operation is configured for instructing to edit a scene element in the virtual scene, and the scene element includes the prefab instance; and the updating module 1120 is further configured to update, in response to receipt of a storage operation on the virtual scene, the prefab resource corresponding to the prefab instance based on the storage operation.

In summary, by the apparatus provided in this embodiment, in a process of developing a parasitic program, a prefab instance is generated by creating a prefab file, so that the efficiency of creating identical instances in the parasitic program is improved, the problems of a large resource occupation and a relatively complicated development process caused by generating identical instances by copying are avoided, and the efficiency of human-computer interaction is improved.

According to the resource configuration apparatus based on the parasitic program provided in the foregoing embodiments, the above functional modules are only described for exemplary purposes. In actual applications, the functions may be allocated to different functional modules according to specific needs, which means that the internal structure of the apparatus is divided to different functional modules to complete all or some of the above described functions. In addition, the resource configuration apparatus based on the parasitic program provided in the embodiments and the embodiments of the resource configuration method based on the parasitic program provided in the foregoing embodiments belong to one conception. For a specific implementation process, refer to the method embodiments, and details are not described herein again.

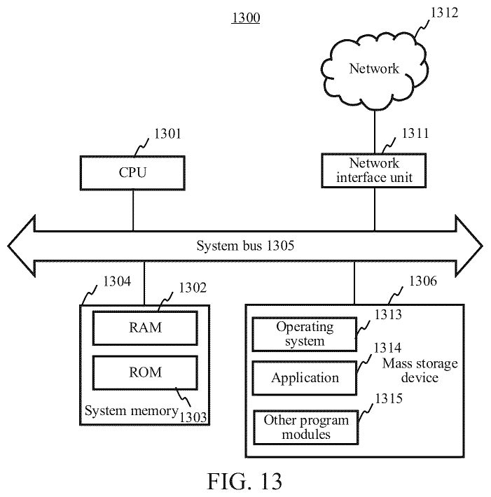

FIG. 13 is a schematic structural diagram of a computer device according to an exemplary embodiment of this application. The computer device may be a device such as a terminal or a server.

Specifically as follows: the computer device 1300 includes a central processing unit (CPU) 1301, a system memory 1304 including a random access memory (RAM) 1302 and a read-only memory (ROM) 1303, and a system bus 1305 connecting the system memory 1304 and the CPU 1301. The computer device 1300 further includes a mass storage device 1306 for storing an operating system 1313, an application program 1314, and other program modules 1315.

The mass storage device 1306 is connected to the CPU 1301 by using a mass storage controller (not shown) connected to the system bus 1305. The mass storage device 1306 and a computer-readable medium associated with the large-capacity storage device provide non-volatile storage to the computer device 1300. That is, the mass storage device 1306 may include a computer-readable medium (not shown) such as a hard disk or a compact disc ROM (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in art may know that the computer storage medium is not limited to the foregoing several types. The system memory 1304 and the mass storage device 1306 may be collectively referred to as a memory.

According to the embodiments of this application, the computer device 1300 may further be connected, through a network such as the Internet, to a remote computer on the network and run. That is, the computer device 1300 may be connected to a network 1312 by using a network interface unit 1311 connected to the system bus 1305, or may be connected to another type of network or a remote computer system (not shown) by using a network interface unit 1311.

The memory further includes one or more programs, which are stored in the memory and are configured to be executed by the CPU.

The embodiments of this application further provide a computer device, which can be implemented as a terminal or a server as shown in FIG. 2. The computer device includes a processor and a memory, the memory having at least one computer-readable instruction, at least one program, a code set, or a computer-readable instruction set stored, and the at least one computer-readable instruction, the at least one program, the code set, or the computer-readable instruction set being loaded and executed by the processor, to implement the resource configuration method based on the parasitic program according to the foregoing method embodiments.

The embodiments of this application further provide a non-transitory computer-readable storage medium, the storage medium having at least one computer-readable instruction, at least one program, a code set, or a computer-readable instruction set stored, the at least one computer-readable instruction, the at least one program, the code set, or the computer-readable instruction set being loaded and executed by a processor, to implement the resource configuration method based on the parasitic program according to the foregoing method embodiments.

An embodiment of this application further provides a computer program product or a computer program, the computer program product or the computer program including computer-readable instructions, the computer-readable instructions being stored in a computer-readable storage medium. A processor of the computer device reads the computer-readable instructions from the computer-readable storage medium, and the processor executes the computer-readable instructions, so that the computer device executes the resource configuration method based on the parasitic program according to any one of the foregoing embodiments.

In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this application are merely for description purpose but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A resource configuration method based on a parasitic program running on a host program performed by a computer device, the method comprising:
generating a prefab file in response to a prefab file generation operation, the prefab file comprising a prefab resource, the prefab resource being configured for generating a prefab instance displayed in a virtual scene of the parasitic program;
in response to receipt of a first editing operation on the prefab resource, updating the prefab resource according to the first editing operation;
in response to receipt of an instance generation operation, generating a prefab instance corresponding to the prefab resource based on configuration data of an instance performance feature in the prefab resource; and
in response to receipt of a scene construction operation, generating the virtual scene in the parasitic program based on the prefab instance, the virtual scene comprising the prefab instance.

2. The method according to claim 1, wherein the updating the prefab resource according to the first editing operation comprises:
receiving a first selection operation on the prefab file;
displaying, in response to the first selection operation, prefab resource content in the prefab file, wherein the prefab resource content is configured for characterizing a performance feature of the prefab instance corresponding to the prefab resource; and
receiving a second editing operation on the prefab resource content, and updating the prefab resource based on the second editing operation.

3. The method according to claim 1, wherein the updating the prefab resource according to the first editing operation comprises:
displaying a prefab reference instance corresponding to the prefab resource in the reference scene; and
receiving an adjustment operation on the prefab reference instance, and updating the prefab resource based on the adjustment operation.

4. The method according to claim 3, wherein the receiving an adjustment operation on the prefab reference instance, and updating the prefab resource based on the adjustment operation comprise:
receiving a visual adjustment operation on the prefab reference instance; and
updating, in response to receipt of a confirmation operation for the visual adjustment operation, the prefab resource based on the visual adjustment operation.

5. The method according to claim 1, wherein the method further comprises:
in response to receipt of a reverting operation on the prefab resource, reverting the prefab resource content back to content before at least one editing operation.

6. The method according to claim 5, wherein the reverting the prefab resource content back to content before at least one editing operation comprises:
reverting, in response to receipt of a first reverting operation on the prefab resource, the prefab resource content back to initial content, wherein the initial content is content of the prefab resource when generated.

7. The method according to claim 5, wherein the reverting the prefab resource content back to content before at least one editing operation comprises:
displaying, in response to receipt of a second reverting operation on the prefab resource, a historical editing option, wherein the historical editing option comprises an editing operation received within a historical period of time; and
reverting, in response to receipt of a third selection operation on an i^{th} editing option, the prefab resource back to content after an i^{th} editing operation, wherein i is a positive integer.

8. The method according to claim 5, wherein the reverting the prefab resource content back to content before at least one editing operation comprises:
displaying, in response to receipt of a second reverting operation on the prefab resource, a historical editing option, wherein the historical editing option comprises an editing operation received within a historical period of time; and
reverting, in response to receipt of a fourth selection operation on the i^{th} editing option, the prefab resource back to content before an i^{th} editing operation, wherein i is a positive integer.

9. The method according to claim 1, wherein the generating a prefab instance corresponding to the prefab resource based on configuration data of an instance performance feature in the prefab resource comprises:
generating, in response to receipt of the instance generation operation, at least two prefab instances corresponding to the prefab resource based on the configuration data of the instance performance feature in the prefab resource, wherein the at least two prefab instances correspond to a same prefab resource identifier, the at least two prefab instances respectively correspond to different intra-resource instance identifiers and different in-scene instance identifiers, and the prefab resource identifier is configured for identifying the prefab resource.

10. The method according to claim 9, wherein the method further comprises:
when the resource content of the resource prefab resource is updated and an instantiation operation on the prefab resource is received, updating the at least two prefab instances corresponding to the prefab resource identifier based on updated resource content of the prefab resource.

11. The method according to claim 9, wherein the method further comprises:
packing, in response to a pack operation on a first prefab instance identified by a first intra-resource instance identifier, the first prefab instance to a second prefab instance indicated by the pack operation, and updating the prefab resource.

12. The method according to claim 9, wherein the method further comprises:
modifying, in response to a modification operation on a third prefab instance identified by a first in-scene instance identifier, the third prefab instance in a modification mode indicated by the modification operation, and generating a scene resource corresponding to the modification operation.

13. The method according to claim 1, wherein the method further comprises:
receiving a scene editing operation on the virtual scene, wherein the scene editing operation is configured for instructing to edit a scene element in the virtual scene, and the scene element comprises the prefab instance; and
updating, in response to receipt of a storage operation on the virtual scene, the prefab resource corresponding to the prefab instance based on the storage operation.

14. A computer device comprising a processor and a memory, the memory having at least one program, the at least one program, when loaded and executed by the processor, causing the computer device to implement a resource configuration method based on a parasitic program running on a host program, the method including:
generating a prefab file in response to a prefab file generation operation, the prefab file comprising a prefab resource, the prefab resource being configured for generating a prefab instance displayed in a virtual scene of the parasitic program;
in response to receipt of a first editing operation on the prefab resource, updating the prefab resource according to the first editing operation;
in response to receipt of an instance generation operation, generating a prefab instance corresponding to the prefab resource based on configuration data of an instance performance feature in the prefab resource; and
in response to receipt of a scene construction operation, generating the virtual scene in the parasitic program based on the prefab instance, the virtual scene comprising the prefab instance.

15. The computer device according to claim 14, wherein the updating the prefab resource according to the first editing operation comprises:
receiving a first selection operation on the prefab file;
displaying, in response to the first selection operation, prefab resource content in the prefab file, wherein the prefab resource content is configured for characterizing a performance feature of the prefab instance corresponding to the prefab resource; and
receiving a second editing operation on the prefab resource content, and updating the prefab resource based on the second editing operation.

16. The computer device according to claim 14, wherein the updating the prefab resource according to the first editing operation comprises:
displaying a prefab reference instance corresponding to the prefab resource in the reference scene; and
receiving an adjustment operation on the prefab reference instance, and updating the prefab resource based on the adjustment operation.

17. The computer device according to claim 14, wherein the method further comprises:
in response to receipt of a reverting operation on the prefab resource, reverting the prefab resource content back to content before at least one editing operation.

18. The computer device according to claim 14, wherein the generating a prefab instance corresponding to the prefab resource based on configuration data of an instance performance feature in the prefab resource comprises:
generating, in response to receipt of the instance generation operation, at least two prefab instances corresponding to the prefab resource based on the configuration data of the instance performance feature in the prefab resource, wherein the at least two prefab instances correspond to a same prefab resource identifier, the at least two prefab instances respectively correspond to different intra-resource instance identifiers and different in-scene instance identifiers, and the prefab resource identifier is configured for identifying the prefab resource.

19. The computer device according to claim 14, wherein the method further comprises:
receiving a scene editing operation on the virtual scene, wherein the scene editing operation is configured for instructing to edit a scene element in the virtual scene, and the scene element comprises the prefab instance; and
updating, in response to receipt of a storage operation on the virtual scene, the prefab resource corresponding to the prefab instance based on the storage operation.

20. A non-transitory computer-readable storage medium having at least one program, the at least one program, when loaded and executed by a processor of a computer device, causing the computer device to implement a resource configuration method based on a parasitic program running on a host program, the method including:
generating a prefab file in response to a prefab file generation operation, the prefab file comprising a prefab resource, the prefab resource being configured for generating a prefab instance displayed in a virtual scene of the parasitic program;
in response to receipt of a first editing operation on the prefab resource, updating the prefab resource according to the first editing operation;
in response to receipt of an instance generation operation, generating a prefab instance corresponding to the prefab resource based on configuration data of an instance performance feature in the prefab resource; and
in response to receipt of a scene construction operation, generating the virtual scene in the parasitic program based on the prefab instance, the virtual scene comprising the prefab instance.
